(19) United States
(12) Patent Application Publication
(10) Pub. No.: US 2015/0180748 A1
(43) Pub. Date: Jun. 25, 2015

(54) METHOD AND APPARATUS OF WebRTC MEDIA CONTROL

(71) Applicant: Futurewei Technologies Inc., Plano, TX (US)

(72) Inventors: Xinmin Ding, San Jose, CA (US); Huipeng Ren, Santa Clara, CA (US); Yilin Gan, San Ramon, CA (US)

(73) Assignee: Futurewei Technologies Inc., Plano, TX (US)

(21) Appl. No.: 14/137,322

(22) Filed: Dec. 20, 2013

(51) Int. Cl. H04L 12/26

(52) U.S. Cl. CPC H04L 43/08

(57) ABSTRACT

A method, device and system configured to support webRTC media communications. The method includes a webRTC client initiating a media connection with a signaling server serving the webRTC client. A monitor server obtains server performance metrics from each of a plurality of media gateway (GW) servers and responsively provides the signaling server with the assigned media GW server as a function of the performance metrics. The monitor server is configured to communicate with a plurality of media GW servers in the network. The monitor server is configured to execute a background process on performance metrics of each of the plurality of media GW servers, and determine a preferred media GW server from the plurality of media GW servers for the webRTC client. The system is configured to support webRTC media communications to connect a webRTC client to a preferred media GW server based on the performance of the media GW servers.

### TECHNICAL FIELD

The present disclosure is generally directed to Web Real Time Communication (webRTC) networks, and more particularly to enabling efficient real-time media control to support communications between browsers.

### BACKGROUND

Today's data centers host real time communication services on multiple servers, with a front-end load balancer directing each client request to a particular server. Within a single data center or enterprise, a front-end load balancer typically directs each client request to a particular server. A dedicated load balancer using consistent hashing is a popular solution today, but it suffers from being an expensive additional piece of hardware and has limited customizability. Dedicated load balancers are expensive and quickly become a single point of failure and congestion. The load balancer is a bottleneck for scalability.

The traditional load balancer algorithm of least connection used, round robin etc. does not have access to webRTC specific performance data. Thus, the user experience can be unpredictable and inconsistent. The webRTC real time media communication requires real time response to be as short as possible. The load balancer introduces extra layer processing delays the response time especially from the media. For websocket and media processing, the number of opened ports for a load balancer has limitations. The centralized load balancer makes Datagram Transport Layer Security (DTLS) into two segments which make the secure context implementation complicated. Moreover, the network access translation (NAT) issue introduced potentially affects the effectiveness of media communication.

There is desired an alternative approach to enable webRTC communications that eliminates front-end load balancers to enable scaling webRTC applications based on a network having a distributed architecture.

### SUMMARY

The present disclosure includes a method, device and system for webRTC media control.

In a first embodiment, a method of operating a network configured to support webRTC media communications is provided. The method includes a monitor server having a processor obtaining server performance metrics from each of a plurality of media servers by monitoring performance of the plurality of media servers. The plurality of media servers are configured to support a webRTC client, wherein each of the media servers have a monitor agent monitoring the performance metrics of the respective media server. The monitor server creates a server configuration pool of the plurality of media servers based on the associated performance of each of the plurality of media servers. When the monitor server receives a request for an assigned media server, the monitor server responsively provides the assigned media server as a function of the server configuration pool. The monitor server may perform big data analysis of each of the plurality of media servers to generate the server configuration pool.

In a second embodiment, a monitor server for use in a network is configured to support webRTC media communications of a webRTC client. The monitor server is configured to communicate with a plurality of media GW servers in the network, each of the plurality of media GW servers configured to communicate media content between the webRTC client and an endpoint. The monitor server is configured to execute a background process on performance metrics of each of the plurality of media GW servers, and determine a preferred media GW server from the plurality of media GW servers for the webRTC client.

In a third embodiment, a network system is configured to support webRTC media communications between a webRTC client and one of a plurality of media GW servers based on the performance of the media GW servers. The system comprises a plurality of media servers, a monitor server configured to obtain server performance metrics of each of the plurality of media servers, and a signaling server configured to serve a webRTC client and establish a signaling connection with the webRTC client. The signaling server is configured to request the monitor server for an assigned media server from the plurality of media servers, and the monitor server is configured to responsively provide the signaling server with the assigned media server for the webRTC client and enable the webRTC client to establish a media connection with the assigned media server. The monitor server is configured to periodically communicate with the plurality of media servers and obtain a pool of server performance metrics of each said media server. The monitor server may be configured to execute a background process and determine the assigned media server for the webRTC client based on a location of the webRTC client and also network delay environment parameters of the network.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a webRTC network including a webRTC gateway according to one aspect of the disclosure;

FIG. 2 illustrates a webRTC network including a monitor server communicating with a plurality of media servers and a signaling server to established a preferred path from a webRTC client and an endpoint;

FIG. 3 illustrates a message flow diagram of the network;

FIG. 4 illustrates a block diagram of analyzing the performance of the media servers;

FIG. 5 illustrates a sample of webRTC related metrics;

FIG. 6 illustrates an analysis engine configured to rank media servers based on inputs;

FIG. 7 illustrates an embodiment of a network unit; and

FIG. 8 illustrates a typical, general-purpose network component.

### DETAILED DESCRIPTION

Enabling real-time communication in a browser is one of the most significant additions to the web platform since its very beginning. WebRTC breaks away from the familiar client-to-server communication model, which results in a full re-engineering of the networking layer, and also brings a whole new media processing mechanism, which is required to enable efficient, real-time processing of audio and video.

WebRTC's primary purpose is to enable real-time communication between browsers. It is designed such that it can be integrated with existing communication systems: voice over Internet Protocol (IP) (VOIP), various Session Initiation Protocol (SIP) clients, and even the public switched telephone network (PSTN). As the coder/decoders (codecs) used for these devices are different from webRTC, the media gateway (GW) server needs to do transcoding for both video (H.264, Vp8) and audio (Opus, H.711 and more).

Enabling a webRTC experience in the browser requires that the browser be able to access the system hardware to capture both audio and video with no third-party plug-ins and custom drivers, just the webRTC application programming interface (API). However, raw audio and video streams are also not sufficient on their own. In inter-connect cases (PSTN, SIP), each stream must be processed by the media server to do transcoding, also synchronized, and the output bit rate must adjust to the continuously fluctuating bandwidth and latency between the clients.

The audio stream is processed for noise reduction and echo cancellation, and then it is automatically encoded with one of the optimized narrowband or wideband audio codecs. The video engine performs similar processing by optimizing image quality, picking the optimal compression and codec settings, applying jitter and packet-loss concealment, and more.

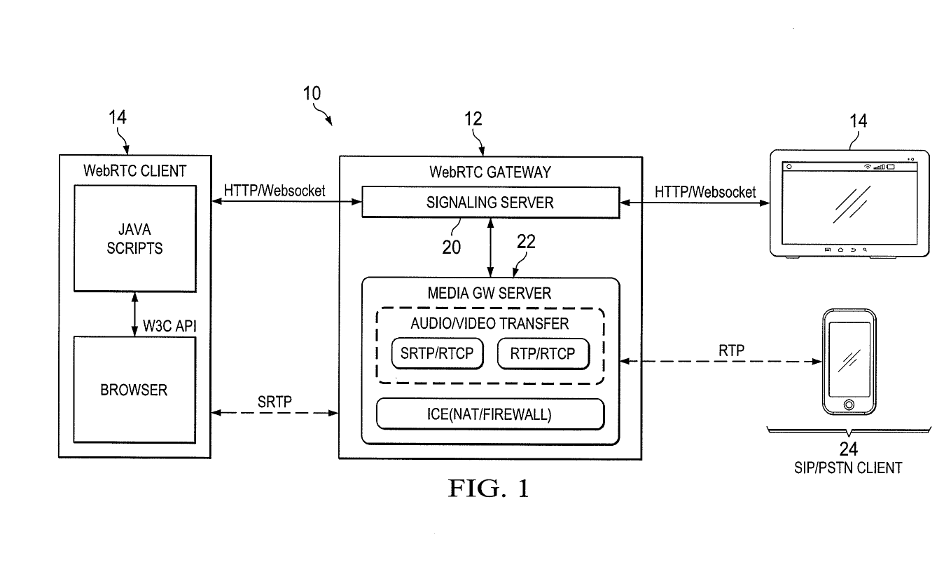

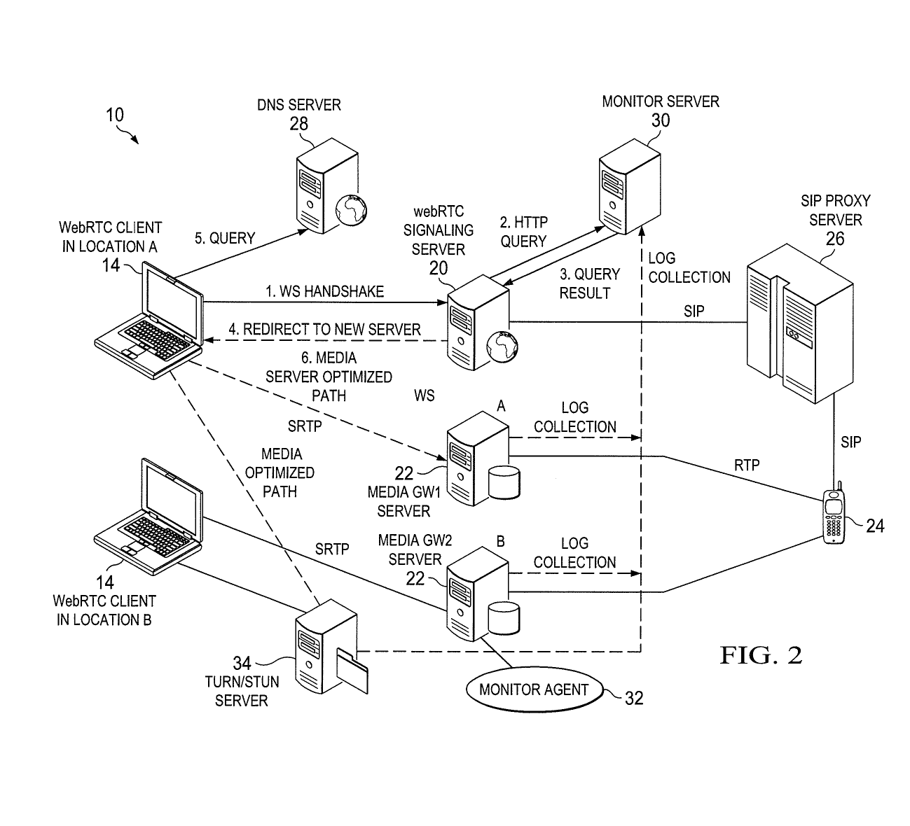

All of the processing is done by the browser, and even more importantly, the browser dynamically adjusts its processing pipeline to account for the continuously changing parameters of the audio and video streams and networking conditions. Once all of this work is done, the web application receives the optimized media stream, which can then be output to the local screen and speakers. A first embodiment of a network 10 with a distributed architecture supporting webRTC applications according to this disclosure is shown in FIG. 1. According to the present disclosure, a webRTC gateway 12 is introduced between various communication end points, including webRTC clients 14, and a SIP proxy server infrastructure (FIG. 2) serving SIP/PSTN client 24. The webRTC gateway 12 includes a signaling server 20 that is configured to handle the setup of the communication channels for media exchange between the webRTC clients 14 and SIP/PSTN client 24. The signaling server 20 is the signaling negotiation stage that receives the media server communication address for each media GW server 22 for processing. Once the signaling process is done, the media GW server 22 responsively starts to convert the media format, terminate Interactive Connectivity Establishment (ICE), and convert between Secure Real-time Transport Protocol (SRTP) and Real-time Transport Protocol (RTP). Besides the network delay time between client and server, the heavy computation of codec conversion tasks extra time for delay. Unlike traditional hardware digital signal processor (DSP) based centralized media gateway deployment, the cloud based media GW server 22 deployment provides a very cost effective way to scale the network 10 to establish more coverage worldwide. In this disclosure, the network path selection can be a critical path for user experience.

Specifically, this disclosure finds the fastest response media GW server 22 between the two communication points when a connection between browsers is established. There are many metrics collected in order to measure real time network conditions. All these metrics are related, but are indirect to, a user's final experience. The present disclosure combines the media GW server performance metrics and the final user's client performance feedback (score system) to establish a more complete picture as to how the media GW servers perform, and enable the best and fastest media GW server 22 to be utilized.

When an application is deployed across a geographical region it is the best practice to always choose the media GW server 22 that has fastest response.

FIG. 2 further illustrates network 10 with the distributed architecture in more detail. The network 10 consists of the webRTC clients 14, signaling server 20, media GW servers 22, SIP/PSTN client 24, a SIP proxy server 26, a domain name system (DNS) server 28, a monitor server 30 providing analysis, and a Traversal Using Relays around NAT (TURN)/Session Traversal Utilities for NAT (STUN)server 34. Each media GW server 22 is in the cloud and has its own published IP address. Before the media traffic starts, the signalling server 20 enables the originating webRTC client 14 to obtain an assigned media server address from the monitor server 30. The monitor server 30 includes a set of data analysis backend processes, and identifies the best media GW server 22 for the webRTC client 14 based on the client location, as well as network delay environment parameters and historical data. The monitor server 30 directs the webRTC client 14 to directly communicate with the selected media GW server 22. The TURN/STUN server 34 has protocols allowing a client behind a NAT or firewall to receive incoming data from the network.

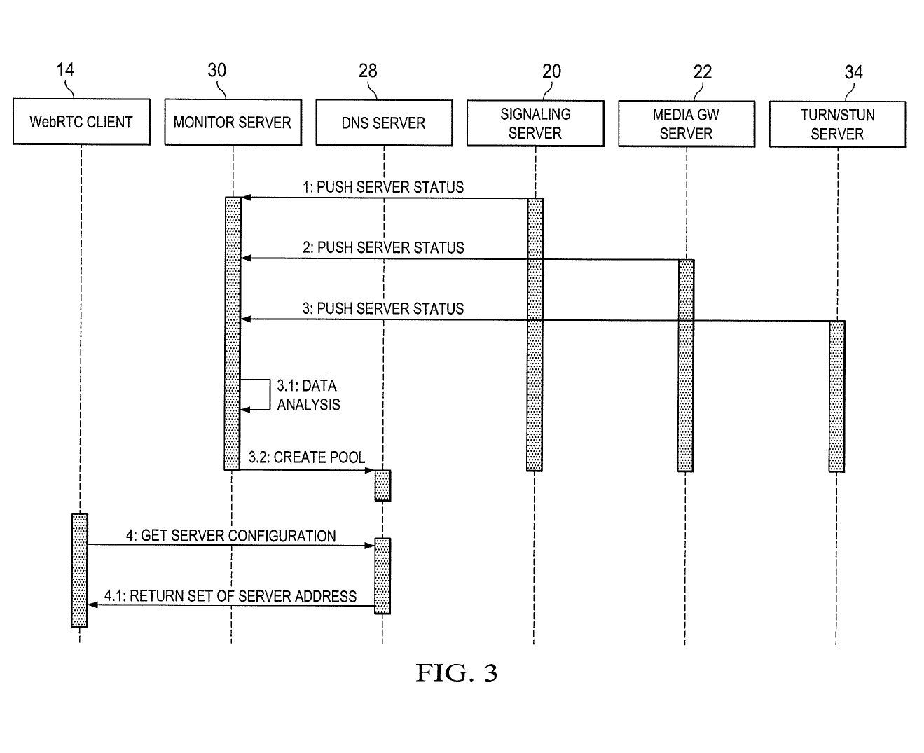

Referring to FIG. 3, there is shown a signaling diagram illustrating server communications before a webRTC client 14 makes a call. In advance of a webRTC client 14 initiating a call by communicating with the DNS server 28, the signaling server 20, the media servers 22, and the TURN/STUN server 34 will have already updated the monitor server 30 with their respective server performance metrics and status. As shown, at step 1 the signaling server 20 pushes its respective server performance metric and status. At step 2 the media GW servers 22 pushes their respective server performance metrics and status. At step 3 the TURN/STUN server 34 pushes its respective server performance metric and status. At step 3.1 the monitor server 30 performs data analysis on the server performance metrics and status, and at step 3.2 creates a pool of media gateways 22 available for utilization upon a call request. At step 4 the webRTC client 14 requests a server configuration from the DNS server 28. At step 4.1, the DNS server 28 returns a set of server addresses.

Referring now back to FIG. 2, the steps of completing a call by webRTC client 14 to SIP/PSTN client 24 are shown and execute the following steps:

At step 1, the webRTC client 14 initiates a websocket handshake with the geographically closest signaling server 20 that is identified by the DNS server 28 in response to a query.

At step 2, the signaling server 20 forwards the request as a HTTP query to the monitor server 30, to obtain the media GW server 22 candidate which is based on certain predetermined rules.

At step 3, the monitor server 30 returns a best signaling server 20 (if the present signaling server 20 is not) and the optimized media GW server 22 to be utilized.

At step 4, the signaling server 20 returns a forward request to the webRTC client 14 if there are any better signaling servers 20 other than current assigned one.

At step 5, if so, the webRTC client 14 makes a new connection with the identified optimized signaling server 20.

At step 6, the webRTC client 14 then passes media to the optimized media GW server 22.

For all this to work, each media GW server 22 contains an application called the monitor agent 32 which provides the respective media GW server performance and logs to the monitor server 30. The monitor server 30 calculates a list of media GW servers 22 for a requesting webRTC client 14 to use based on an analysis algorithm. In the meantime, the client application executing in the monitor server 30 supplies the monitor server 30 with the location of all of the media GW servers 22 so that it can routinely check all of the media GW servers 22.

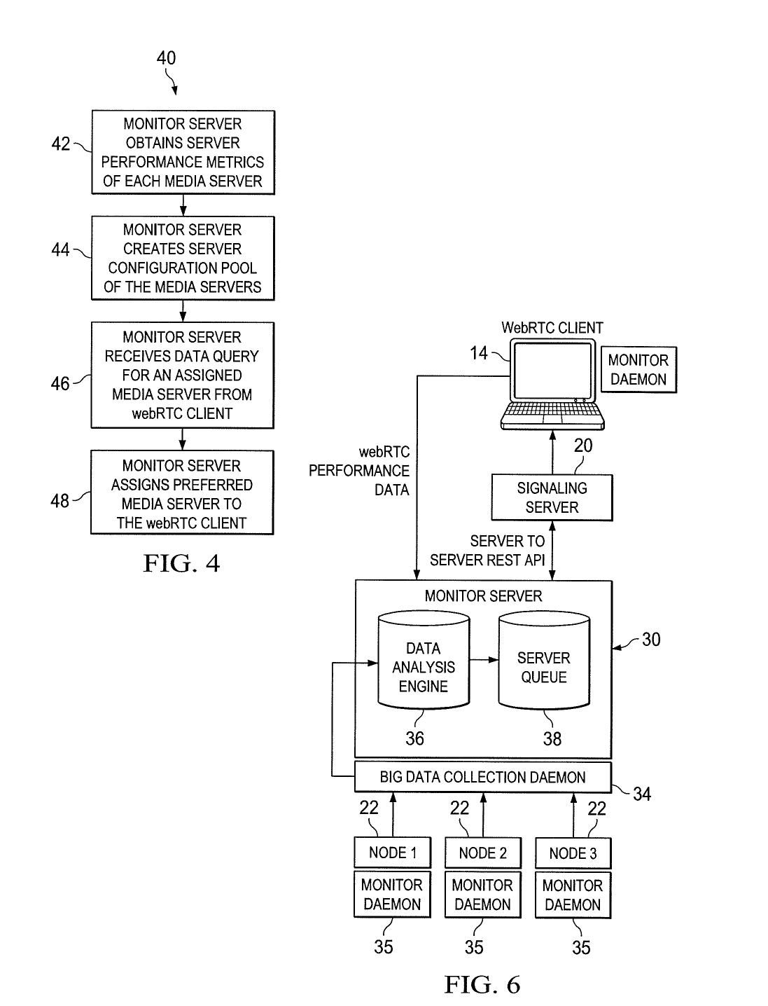

Referring to FIG. 4, there is shown a flow diagram 40 of one embodiment of the disclosure for assigning a preferred media server 22 to a webRTC client 14, with reference to FIG. 2.

At step 42, the monitor server 30 having a processor obtains server performance metrics from each of the media servers 22 by monitoring performance of the media servers 22. Each of the media servers 22 are configured to support a webRTC client 14, wherein each of the media servers 22 have a monitor agent 32 comprising a monitor daemon 35 (FIG. 6) monitoring the performance metrics of the respective media server 22.

At step 44, the monitor server 30 creates a server configuration pool of the media servers 22 based on the associated performance of each of the media servers 22, such as by periodically fetching performance metrics of each media server 22. The monitor server 30 performs big data analysis of the performance metrics of each of the media servers 22 to generate the server configuration pool, using big data collection daemon 34 (FIG. 6). The server configuration pool may comprise a first server list A including all the available media servers, and a second server list B based on the first list and performance metrics of the media servers. The second server lists may comprise only the media servers that have performance metrics that meet a predetermined acceptable performance metric.

At step 46, the monitor server 30 receives a data query request for an assigned media server 22 from the webRTC client 14

At step 48, the monitor server 30 executes a background process and determines a preferred media server 22 from the plurality of media servers 22 for the webRTC client 14 based on a location of the webRTC client 14 and also network delay environment parameters of a network, and assigns the preferred media server 22 to the webRTC client 14.

In addition, the monitor server 30 processes history data of each of the plurality of media servers 22, and provides the signaling server 20 with the assigned media server 22 as a function of both the performance metrics and the history data. The monitor server 30 negotiates with the signaling server 20 to determine the preferred media server 22 based on parameters of the webRTC client 14. The monitor server 30 also identifies a preferred signaling server 20 from a plurality of signaling servers 20, and enables the webRTC client 14 20 to subsequently communicate with the preferred signaling server 20 to handle a media connection.

The following detailed example is provided to further illustrate aspects of the present disclosure, illustrating webRTC client 14 establishing communication with a preferred media GW server 22, selected from media GW server A and media GW server B. It is noted in this example that only media GW servers A and B are shown as available in FIG. 2 for clarity; however, more than two media GW servers 22 may be provided in the network and utilized by the webRTC client 14. The monitor server 30 constantly communicates with the available media GW servers 22, in this example, A and B.

The webRTC client 14 sends a data query request to monitor server 30, via signaling server 20, for an available media GW server 22. The monitor server 30 initially generates a list A including available media GW servers 22 based on the webRTC 14 location, in this example, A and B. The monitor server 30 then generates a list B of available media GW servers 22 based on the media GW servers of list A by removing those media GW servers 22 based on predetermined criteria, such as those having high central processing unit (CPU), high input/output (I/O), and/or memory usage. The monitor server 30 outputs those available media GW servers of list B with some media GW servers 22 filtered out based on one or more quality evaluation metrics, such as webRTC client 14 history logs in the same area. In this example, media GW server A is selected.

If media GW server B suddenly becomes disabled, the monitor server 30 realizes this and it will no longer send decodes to server B, it will simply use media GW server A. However, if media GW server B comes back online, the monitor server 30 sees this and will begin sending decodes once again. This is good for redundancy and failover. The monitor server 30 also keeps track of how busy the media GW servers 22 are. So, if media GW server A suddenly becomes very busy, the request for media would be sent to media GW server B. New media requests are sent to the media server GW 22 that is least busy. Advantageously, network 10 automatically performs a type of load balancing when multiple media GW servers 22 are set up.

In addition, the media GW server 22 candidate initially returned from DNS server 28 may not be the best candidate. The DNS server 28 simply identifies the media GW server 22 in a certain region. In the same region there can be many media GW servers 22. If the DNS server 28 assigned a media GW server 22 that is good enough, the webRTC client 14 will continue to use this assigned media GW server. But if the assigned media GW server 22 is not suitable (i.e. the server returned may be overloaded or the webRTC client score is low), this disclosure provides a mechanism to shift the media communication to another available media GW server 22 by querying the monitor server 30 to identify which exact media GW server 22 in this/that region is good based on established rules. After that, before the media communication starts to flow between a webRTC client 14 and an endpoint, the mechanism shifts the signaling server. Below is typical websocket handshake:

GET /chat HTTP/1.1

Host: server.example.com

Upgrade: websocket Connection:

Upgrade Sec-WebSocket-Key: dGhlIHNhbXBsZSBub25jZQ==Origin: http://example.com

Sec-WebSocket-Protocol: chat, superchat

Sec-WebSocket-Version: 13

HTTP/1.1 101

Switching Protocols

Upgrade: websocket

Connection: Upgrade

Sec-WebSocket-Accept: s3pPLMBiTxaQ9kYGzzhZRbK+xOo=

The below message shows how to perform a redirect through a websocket handshake.

Then, the device will make a websocket with the new server.

GET /chat HTTP/1.1

Host: server.example.com

Upgrade: websocket Connection:

Upgrade Sec-WebSocket-Kaey: dGhlIHNhbXBsZSBub25jZQ==Origin: http://example.com

Sec-WebSocket-Protocol: chat, superchat

Sec-WebSocket-Version: 13

HTTP/1.1 303 See Other Location: http://newSigalingserver?mediaServer=173.2.34.7

This tells the signaling server 20 that the best media GW server 22 to use for media is 173.2.33.7. This gives a dynamic way to associate the media GW server 22 with the webRTC client 14, instead of a setup based on a fixed media server address. When the webRTC signaling gateway 20 continues the normal flow of session description protocol (SDP) negotiation the targeted media GW server 22 will use this address.

The purpose of monitoring is to collect the performance log from the monitor agent 32 in order to make further analysis and decide which media GW server 22 is to be assigned to webRTC client 14. Like in other systems, monitoring in an environment starts with the basics: System Metrics—CPU, Disk, and Memory. Besides CPU and memory utilization, Disk utilization, and of course I/O throughput, is of high importance. After all, the most likely bottleneck in a big data system is I/O—either with codec (network and disk), moving data around (e.g. media) and straight forward read/write to disk.

Besides the media GW server performance data, client performance data with this media GW server 22 is collected and correlated to give a better picture of how the media GW server 22 performed for the webRTC task. The WebRTC related metrics is kind of a user experience score for the media GW server performance based on the webRTC client 14 location.
Average network delay time from the client location—this is achieved from the big data analysis from history information collected in the past 2 hours.
Client access network speed—this is achieved from the big data analysis from history information collected in the past 2 hours.
WebRTC Congestional control metrics—loss, discard and duplicated packet count.
WebRTC Quality evaluation metrics—burst packet loss, frame impairment summary, jitter metrics of Real-time Control Protocol (RTCP), jitter buffer metrics, and number of retransmission packets.

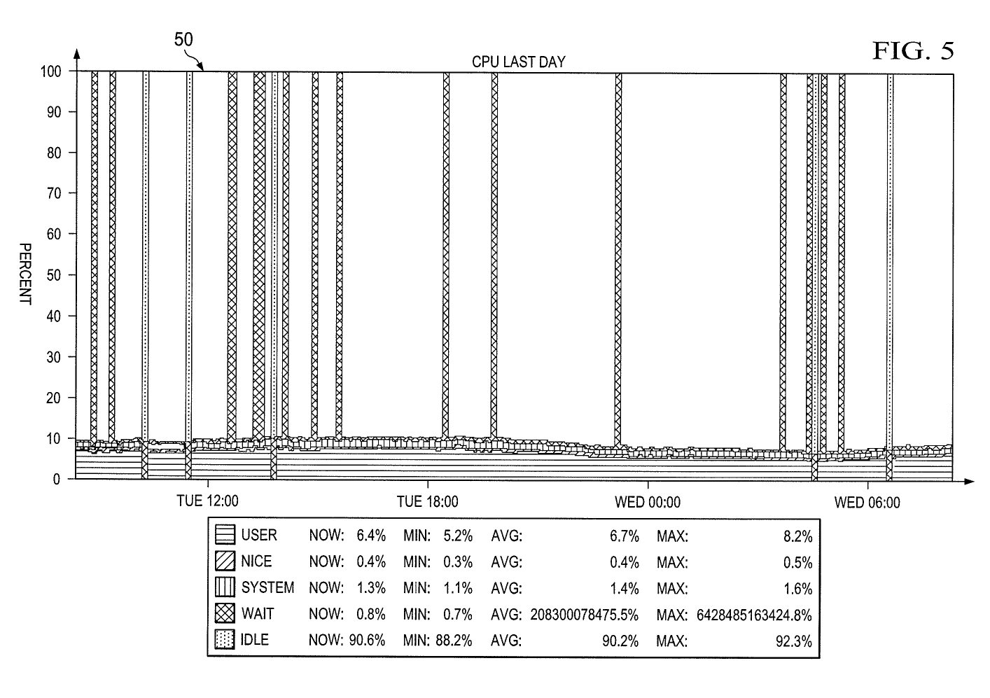

FIG. 5 illustrates a sample of webRTC related metrics at 50.

To make decisions of which media GW server id to be used by the webRTC client 14, the monitor agent 32 collects a set of metrics referred to as the server's performance model. A two stage look-up algorithm is used—the first stage narrows the GW media server candidate list with server performance data. The high central processing unit (CPU), high input/output (I/O) servers are filtered out.

The second stage is based on the client webRTC metrics collected based on past 90 minute performance to give the best candidate server for the signaling server and media GW server selection. For example, when a webRTC client 14 makes a call, a data analysis engine 36 picks the history data in this location which include a media GW server's score. An example of this is the busier the media server is the lower the score is, and the more jitter time from the webRTC client feedback the lower the score. There are a lot more of these variables consolidated and used for data analysis purpose.

Referring to FIG. 6, there is shown a system diagram illustrating the signaling sever 20 and the monitor server 30 communicating with the webRTC client 14, with the monitor server 30 communicating with the respective monitor agents 32 of the media GW servers 22 comprising nodes in the network. The monitor server 30 includes a big data collection daemon 34 configured to communicate with the monitor daemons 35 comprising the monitor agents 32 of each media GW server 22 as shown in FIG. 2. The monitor server 30 includes the data analysis engine 36 configured to perform data analysis, and an associated server queue 38. The monitor server 30 may include an operating system that provides executable program instructions for the administration and operation of that server, and typically will include a computer-readable medium storing instructions that, when executed by a processor of the monitor server 30, allow the monitor server 30 to perform its intended functions as described above. One function of the data analysis engine 36 is to rank the media GW servers 22 based on the inputs. The Bayesian algorithm may be used as a way to calculate a weighted score for each of the media GW server 22 based on the general performance data webRTC client feedback data.

Bayesian model weighting is used for making decisions based on data D. A number of models M1 . . . Mn are considered and for each model Mi, P(Mi|D) the probability of the model given the data is calculated. Each of the models are then used for making a prediction f1 . . . fn and each prediction is weighted with the probability P(Mi|D) giving as final prediction F=C åi P(Mi|D).fi where C is a normalizing constant C=åi P(Mi|D).

This disclosure addresses the webRTC communications scalability issue by introducing the smart communication path selection between client and media GW server with the help of environment data collected. The benefits of the distributed architecture include, but are not limited to:

Using real time client feedback performance data to provide the best resource to client.

It eliminates the need of a central server side load balancing the signaling and media GW server, thus reducing the network latency and complexity involved in load balancing.

Load balancing is no longer a single point of failure.

System is easy to scale up with much lower cost for media processing.

Distributed load balancing across geophysical region is easier to achieve.

Less complex processing of SRTP/DTLS and NAT. Instead, the webRTC client communicates with media GW server directly to be more reliable.

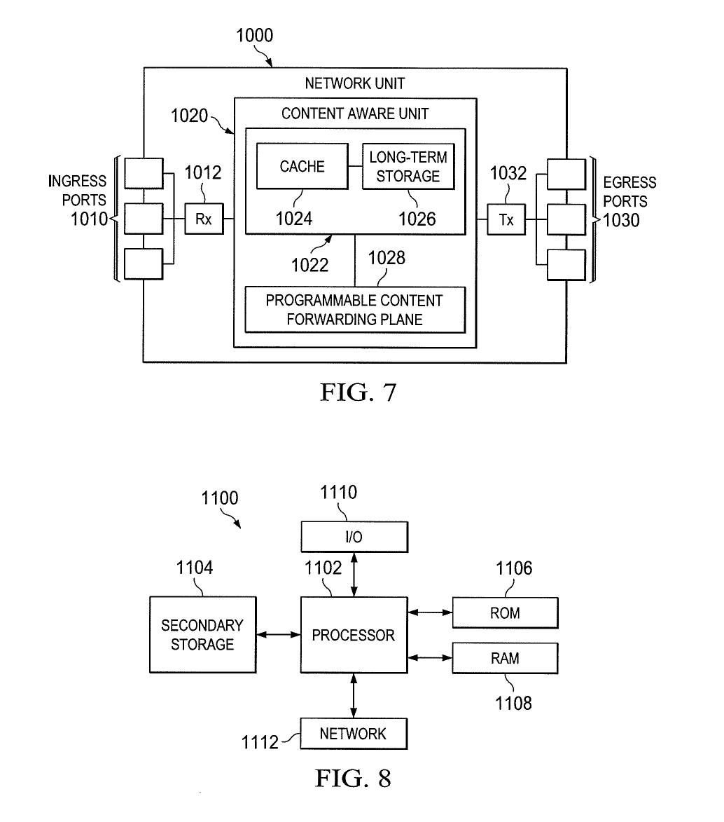

FIG. 7 illustrates an embodiment of a network unit 1000, which may be any device that transports and processes data through network 100. For instance, the network unit 1000 may correspond to or may be located in any of the system nodes described above, for example, the DNS server, the signaling server, the monitor server, the media GW servers, etc. The network unit 1000 may correspond to or may be located in any of the system nodes described above, such as a MN, AoS, content router R, and AS. The network unit 1000 may also be configured to implement or support the schemes and methods described above. The network unit 1000 may comprise one or more ingress ports or units 1010 coupled to a receiver (Rx) 1012 for receiving signals and frames/data from other network components. The network unit 1000 may comprise a content aware unit 1020 to determine which network components to send content to. The content aware unit 1020 may be implemented using hardware, software, or both. The network unit 1000 may also comprise one or more egress ports or units 1030 coupled to a transmitter (Tx) 1032 for transmitting signals and frames/data to the other network components. The receiver 1012, content aware unit 1020, and transmitter 1032 may also be configured to implement at least some of the disclosed schemes and methods above, which may be based on hardware, software, or both. The components of the network unit 1000 may be arranged as shown in FIG. 7.

The content aware unit 1020 may also comprise a programmable content forwarding plane block 1028 and one or more storage blocks 1022 that may be coupled to the programmable content forwarding plane block 1028. The programmable content forwarding plane block 1028 may be configured to implement content forwarding and processing functions, such as at an application layer or L3, where the content may be forwarded based on content name or prefix and possibly other content related information that maps the content to network traffic. Such mapping information may be maintained in one or more content tables (e.g., CS, PIT, and FIB) at the content aware unit 1020 or the network unit 1000. The programmable content forwarding plane block 1028 may interpret user requests for content and accordingly fetch content, e.g., based on meta-data and/or content name (prefix), from the network or other content routers and may store the content, e.g., temporarily, in the storage blocks 1022. The programmable content forwarding plane block 1028 may then forward the cached content to the user. The programmable content forwarding plane block 1028 may be implemented using software, hardware, or both and may operate above the IP layer or L2.

The storage blocks 1022 may comprise a cache 1024 for temporarily storing content, such as content that is requested by a subscriber. Additionally, the storage blocks 1022 may comprise a long-term storage 1026 for storing content relatively longer, such as content submitted by a publisher. For instance, the cache 1024 and the long-term storage 1026 may include Dynamic random-access memories (DRAMs), solid-state drives (SSDs), hard disks, or combinations thereof.

The network components described above may be implemented on any general-purpose network component, such as a computer or network component with sufficient processing power, memory resources, and network throughput capability to handle the necessary workload placed upon it. FIG. 8 illustrates a typical, general-purpose network component 1100 suitable for implementing one or more embodiments of the components disclosed herein. The network component 1100 includes a processor 1102 (which may be referred to as a central processor unit or CPU) that is in communication with memory devices including secondary storage 1104, read only memory (ROM) 1106, random access memory (RAM) 1108, input/output (I/O) devices 1110, and network connectivity devices 1112. The processor 1102 may be implemented as one or more CPU chips, or may be part of one or more application specific integrated circuits (ASICs).

The secondary storage 1104 is typically comprised of one or more disk drives or tape drives and is used for non-volatile storage of data and as an over-flow data storage device if RAM 1108 is not large enough to hold all working data. Secondary storage 1104 may be used to store programs that are loaded into RAM 1108 when such programs are selected for execution. The ROM 1106 is used to store instructions and perhaps data that are read during program execution. ROM 1106 is a non-volatile memory device that typically has a small memory capacity relative to the larger memory capacity of secondary storage 1104. The RAM 1108 is used to store volatile data and perhaps to store instructions. Access to both ROM 1106 and RAM 1108 is typically faster than to secondary storage 1104.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method of supporting Web Real Time Communication (webRTC) client communications, the method comprising:
obtaining, by a monitor server having a processor, server performance metrics from each of a plurality of media servers by monitoring performance of the plurality of media servers, wherein each of the plurality of media servers are configured to support a webRTC client, wherein each of the media servers have a monitor agent monitoring the performance metrics of the respective media server.

2. The method as specified in claim 1, further comprising:
creating, by the monitor server, a server configuration pool of the plurality of media servers based on the associated performance of each of the plurality of media servers.

3. The method as specified in claim 2, further comprising:
performing, by the monitor server, big data analysis of each of the plurality of media servers to generate the server configuration pool.

4. The method as specified in claim 2, further comprising:
receiving, by the monitor server, a request for an assigned media server and responsively providing the assigned media server as a function of the server configuration pool.

5. The method as specified in claim 4, further comprising:
enabling, by the monitor server, the webRTC client to directly connect with the assigned media server.

6. The method as specified in claim 1, further comprising:
executing, by the monitor server, a background process and determining a preferred media server from the plurality of media servers for the webRTC client based on a location of the webRTC client and also network delay environment parameters of a network; and
assigning the preferred media server to the webRTC client.

7. The method as specified in claim 6, further comprising:
processing, by the monitor server, history data of each of the plurality of media servers, and providing a signaling server with the assigned media server as a function of both the performance metrics and the history data.

8. The method as specified in claim 7, further comprising:
negotiating, by the monitor server, with the signaling server to determine the preferred media server based on parameters of the webRTC client.

9. The method as specified in claim 7, further comprising:
identifying, by the monitor server, a preferred signaling server from a plurality of signaling servers, and enabling the webRTC client to subsequently communicate with the preferred signaling server to handle a media connection.

10. The method as specified in claim 2 wherein the server configuration pool comprises a first server list based on the available plurality of media servers, and a second server list based on the first list and performance metrics of the media servers.

11. The method as specified in claim 10 wherein the second server lists comprises only the media servers that have performance metrics that meet a predetermined acceptable performance metric.

12. An apparatus for use in a network configured to support Web Real Time Communication (webRTC) media communications of a webRTC client, the apparatus comprising:
a monitor server;
wherein the monitor server is configured to communicate with a plurality of media servers in the network, each of the plurality of media servers configured to communicate media content between the webRTC client and an endpoint; and
wherein the monitor server is configured to execute a background process on performance metrics of each of the plurality of media servers, and determine a preferred media server from the plurality of media servers for the webRTC client.

13. The apparatus as specified in claim 12 wherein the monitor server is configured to determine the preferred media server based on a location of the webRTC client and also network delay environment parameters of the network.

14. The apparatus as specified in claim 12 wherein the monitor server is configured to periodically communicate with the plurality of media servers to obtain a pool of server performance metrics of each said media server.

15. The apparatus as specified in claim 12 wherein the monitor server is configured to process history data of the plurality of media servers, and provide a signaling server with an identity of the preferred media server as a function of both the performance metrics and the history data.

16. The apparatus as specified in claim 12 wherein the monitor server is configured to negotiate with a signaling server to determine the preferred media server based on parameters of the webRTC client and the media server performance metrics.

17. The apparatus as specified in claim 16 wherein the monitor server is configured to identify a fastest available media server from the plurality of media servers based on the signaling server negotiation, and provide the signaling server with the identified the fastest available media server.

18. The apparatus as specified in claim 12 wherein the monitor server is configured to identify a preferred signaling server from a plurality of signaling servers, and communicate the preferred signaling server to the webRTC client.

19. The apparatus as specified in claim 12 wherein the monitor server is configured to communicate with a monitor agent of each of the plurality of media servers to obtain the performance metrics.

20. The apparatus as specified in claim 19 wherein the monitor server is configured to obtain central processing unit (CPU) usage, memory usage, and bandwidth usage of the plurality of media servers.

21. A system configured to support Web Real Time Communication (webRTC) media communications, the system comprising:
a plurality of media servers;
a monitor server configured to obtain server performance metrics of each of the plurality of media servers; and
a signaling server configured to serve a webRTC client and establish a signaling connection with the webRTC client, wherein the signaling server is configured to request the monitor server for an assigned media server from the plurality of media servers, and wherein the monitor server is configured to responsively provide the signaling server with the assigned media server for the webRTC client and enable the webRTC client to establish a media connection with the assigned media server.

22. The system as specified in claim 21 wherein the monitor server is configured to periodically communicate with the plurality of media servers and obtain a pool of server performance metrics of each said media server.

23. The system as specified in claim 22 wherein the monitor server is configured to execute a background process and determine the assigned media server for the webRTC client based on a location of the webRTC client and also network delay environment parameters of the network.

24. The system as specified in claim 22 wherein the monitor server is configured to process history data of each said media server, and provide the signaling server with the assigned media server as a function of both the pool of server performance metrics and the history data.

25. The system as specified in claim 21 wherein the signaling server is configured to provide the webRTC client with a path including the assigned media server for the webRTC client and establish a media connection with an endpoint.

26. The system as specified in claim 22 wherein the signaling server is configured to negotiate with the monitor server and determine the assigned media server based on parameters of the webRTC client and the pool of server performance metrics.

27. The system as specified in claim 26 wherein the monitor server is configured to identify a fastest available said media server based on the signaling server negotiation, and establish the fastest available said media server as the assigned media server.

28. The system as specified in claim 27 wherein the monitor server is configured to identify a preferred signaling server from a plurality of signaling servers and enable the webRTC client to communicate with the preferred signaling server.

29. The system as specified in claim 28 wherein the signaling server is configured to enable the webRTC client to initiate a websocket handshake with the preferred signaling server identified by a domain name system (DNS) server.

30. The system as specified in claim 21 wherein the assigned media server is configured to convert a media format of media received from the webRTC client.
